(19) United States
(12) Patent Application Publication
(10) Pub. No.: US 2021/0370106 A1
(43) Pub. Date: Dec. 2, 2021

(54) FILTER UNIT WITH A RIGID FILTER AND A FLEXIBLE JACKET AND METHODS FOR MANUFACTURING SUCH A FILTER

(71) Applicant: Dräger Safety AG & Co. KGaA, Lübeck (DE)

(72) Inventors: Ludwig LORENZEN, Lübeck (DE); Rolf MÜLLER, Lübeck (DE); Andreas JUNK, Lübeck (DE); Sören KIRMSE, Lübeck (DE); Tim ERHARDT, Lübeck (DE)

(21) Appl. No.: 17/331,973

(22) Filed: May 27, 2021

(30) Foreign Application Priority Data
Jun. 2, 2020 (DE) 10 2020 114 622.1

(51) Int. Cl. A62B 23/02; B01D 46/00

(52) U.S. Cl. CPC A62B 23/02; B01D 46/0001; B01D 46/0005

(57) ABSTRACT

A filter unit (100) is configured to filter a gas and/or particles out of a gas mixture, especially out of breathing air. A process is provided for manufacturing such a filter unit. A shell surface (M) of a rigid filter (1), for example, including activated carbon, is enclosed by a flexible jacket (3). The jacket is enclosed with a rigid cover (2, 5) at the outflow-side end. The process includes inserting the filter into a shaping body, so that a gap remains between the inner wall of the shaping body and the shell surface (M) of the filter. Free-flowing material is inserted into this gap, and this material forms the jacket after a curing. A second manufacturing process includes cutting a piece off from a tube and pulling over the shell surface (M) of the filter. The piece of tube then forms the jacket of the filter.

### CROSS REFERENCE TO RELATED APPLICATIONS

This application claims the benefit of priority under 35 U.S.C. § 119 of German Application 10 2020 114 622.1, filed Jun. 2, 2020, the entire contents of which are incorporated herein by reference.

### TECHNICAL FIELD

The present invention pertains to a filter unit, which is capable of filtering at least one gas and/or particles out of a gas mixture, especially out of breathing air, as well as to two processes for manufacturing such a filter unit.

### TECHNICAL BACKGROUND

In one application, such a filter unit is a replaceable component of a gas mask. This gas mask comprises the mask core, which a person wears in front of his/her face, and a holder for the mask, for example, a head band, as well as at least one filter unit, and preferably two filter units. A filter unit can typically be screwed into a screw thread or quarter-turn connector of the mask and can be unscrewed again and thereby replaced. The filter unit or each filter unit filters at least one gas, particles and/or coarse dust out of the breathing air to be inhaled and thereby protects the lungs and the airways of the person, who wears the gas mask. Such a gas mask is described, for example, in WO 2019/233 708 A1.

The filter unit comprises at least one filter, which receives a gas and/or the particles. A filter in the form of a monolith, which is manufactured from activated carbon and is capable of filtering at least one gas out of a gas mixture, has become known. A plurality of parallel ducts pass through the filter. Such a filter is described in DE 10 2015 012 410 A1.

A filter unit with a relatively rigid filter is also described in DE 100 21 582 B4 and in DE 103 04 216 B3.

### SUMMARY

A basic object of the present invention is to provide a filter unit for filtering at least one gas and/or particles out of a gas mixture, especially out of breathing air, wherein the filter unit can be used with a higher level of operational reliability than prior-art filter units. Furthermore, the basic object of the present invention is to provide a process for manufacturing such a filter unit.

This object is accomplished by a filter unit having features according to the present invention as well as by a process having features according to the present invention. Advantageous embodiments of the filter unit according to the present invention are, insofar as meaningful, also advantageous embodiments of a process according to the present invention and vice versa.

A person, who uses a filter unit according to the present invention in order to filter the inhaled breathing air, will hereinafter be called “the user”.

The filter unit according to the present invention is configured to filter at least one gas and optionally a plurality of different gases and/or particles out of a gas mixture, while this gas mixture is flowing through the filter unit. The gas mixture may be homogeneous or heterogeneous and is especially breathing air, which may contain harmful gases and solid particles.

The filter unit according to the present invention comprises

a filter,

a jacket (jacketing) formed of an elastically deformable material and

a cover consisting of a rigid material.

The filter unit provides an inflow side and an outflow side. When a gas mixture, from which at least one gas and/or particles are to be filtered out, is flowing through the filter unit, this gas mixture is flowing from the inflow side through the filter unit and it thus flows through the filter to the outflow side. The inflow side has an inflow-side opening, and the outflow side has an outflow-side opening. The gas mixture flows through the inflow-side opening into the filter unit, it flows through the filter, wherein the filter filters the gas or at least one gas or particles out of the gas mixture and it leaves, filtered, the filter unit through the outflow-side opening.

The filter is configured as a rigid body, it extends along a central axis and has a shell surface. The shell surface encloses the central axis at a radial distance. The filter preferably has the shape of a cylinder or of a truncated cone or of a column or of a truncated pyramid with a polygonal cross-sectional area, n>=3. Other geometric shapes are possible as well.

The filter is configured to filter at least one gas and/or particles, and optionally a plurality of gases out of the gas mixture, which flows through the filter.

The jacket of the filter unit encloses the shell surface of the filter and preferably the entire shell surface. The jacket is preferably in contact with the shell surface. The jacket is manufactured from a deformable and hence flexible material, especially from a plastic and/or elastic material. The jacket is capable thereby of absorbing kinetic energy, which acts from the outside on the shell surface and is caused especially by a shock. The jacket is preferably capable of undergoing a reversible deformation when kinetic energy acts from the outside. The jacket encloses the inflow-side opening.

The cover adjoins the jacket at the end of the jacket, which end points towards the outflow side. The cover encloses the outflow-side opening.

The outflow-side opening is formed according to the present invention in the rigid cover. This feature makes it possible to connect a coupling unit to the cover. In particular, a screw thread or a quarter-turn connector and/or the cover can be configured such that they enclose and form the coupling unit. The filter unit can be connected by means of this coupling unit to a mask or to another device, which carries the filter unit, said connection preferably being a detachable connection. The filter unit is held at a defined location at the device. The mechanical stability is increased, because the cover consists of a rigid material.

The filter is made of a rigid body according to the present invention. In many cases, a filter configured as a rigid body offers a relatively low resistance, especially a lower resistance than a filter that is configured differently and has a similar filter performance, to the breathing of a person who uses the filter unit. In particular, a rigid body made of activated carbon, generally a rigid body made of a material that comprises activated carbon, can be used as the filter. Because such a filter in the form of a rigid body offers a relatively low resistance to breathing, the respiratory muscles of the user of the filter unit are stressed to a lesser extent and fatigue of these muscles develops after a longer time only compared to other possible filters with a similar filter performance. In addition, such a rigid filter has in many cases a lower weight than has a filter of a different configuration but with similar filter performance.

Especially because of the lower resistance to breathing, the filter unit according to the present invention makes it possible for the user to be present for a longer time in a room whose air is polluted with at least one harmful gas and/or with particles and/or to have to replace the filter unit less frequently. Nevertheless, the rigid filter according to the present invention is actually capable of attaining a required delivery capacity.

A filter, which is configured as a rigid body, can in many cases be manufactured and/or handled more easily than can a filtering by means of bulk material.

In one embodiment, the rigid filter is configured as a single rigid body. In another embodiment, the rigid filter comprises a sequence of individual rigid bodies. The configuration with the sequence makes it possible for the individual bodies to possess, on the whole, at least two different properties, and the rigid body is therefore capable of filtering different gases out of a gas mixture or it uses different filtration processes. In many cases, both increase the reliability.

One drawback that a filter in the form of a rigid body has is that this rigid filter may break relatively easily under the action of a mechanical force. This mechanical force action occurs, for example, when the filter unit falls on the ground or hits a rigid object during the use or during transportation.

The risk of the filter of the filter unit according to the present invention being mechanically damaged is reduced, on the one hand, by the jacket, which encloses according to the present invention the shell surface as well as the inflow-side opening of the filter and consists of a reversibly deformable material. The jacket is capable of absorbing kinetic energy up to a certain extent based on its deformability and of transmitting it in one embodiment to the rigid cover and hence to a coupling point. On the other hand, the risk of damage is reduced by the outflow-side opening being enclosed according to the present invention with a cover consisting of a rigid material.

The flexible jacket around the shell surface of the filter protects, on the one hand, the filter in many cases from a part of the filter breaking off or from the filter breaking, especially when the filter unit falls on the ground. On the other hand, the jacket protects, in conjunction with the cover, the filter from ambient chemical effects, especially from water and water vapor, and, up to a certain extent, also from ambient thermal effects, doing so both in case of direct exposure to flames and in case of intense heat, especially when the filter unit is used in a smoke-filled or smoky environment.

The filter is preferably manufactured from a material that comprises activated carbon. A plurality of ducts that are parallel to one another are preferably passed through the filter. These ducts connect the inflow side to the outflow side. A gas mixture flows through these ducts, and at least one gas and/or particles are filtered out in the process. The filter may be an impregnated filter.

The filter extends according to the present invention along a central axis. The shell surface encloses this central axis. Each cross section through the filter at right angles to the central axis has the shape of a circle or of an ellipse or of a polygon with n being greater than or equal to 3. It is possible that the filter always has the same cross-sectional area along the central axis or else a cross-sectional area that increases in a direction from the inflow side to the outflow side.

According to the present invention, the jacket is capable of absorbing kinetic energy and is made of an elastic material. The jacket preferably has a resilient effect and it therefore undergoes reversible deformation when a mechanical impulse acts on the jacket from the outside. Kinetic energy is absorbed when the jacket having a resilient configuration is compressed against the spring force. The jacket preferably expands again based on the spring force and it especially preferably resumes the old shape when the mechanical impulse is no longer acting.

In one embodiment, the hardness of the jacket remains the same in a direction from the shell surface to the central axis. In another embodiment, the hardness of the jacket decreases in the direction of the central axis of the filter, or else the elasticity of the jacket increases in the direction of the central axis of the filter. This configuration leads in many cases to an even better mechanical protection of the rigid filter.

The jacket preferably has a thickness of at least 0.1 cm, especially preferably at least 0.5 cm, and especially at least 1 cm. The thickness is defined as the smallest dimension of the jacket in a direction at right angles to the central axis of the filter. Such a thick jacket is capable of protecting the rigid filter better in many cases from a mechanical damage than is a thinner jacket.

It is possible that the thickness of the jacket varies over the extension of the jacket especially because the rigid filter deviates from an ideal geometric shape, for example, because it is not an ideal cylinder. The thickness, which is preferably greater than or equal to 0.1 cm, is defined in this case as the minimal dimension of the jacket in a direction at right angles to the central axis of the filter.

The filter configured as a rigid body extends according to the present invention along a central axis and comprises a shell surface, which encloses the central axis. This shell surface preferably extends from an inflow-side end face to an outflow-side end face. The gas mixture flows from the inflow-side end face to the outflow-side end face. Each end face maybe at right angles or oblique in relation to the central axis. The two end faces may be arranged in parallel or obliquely to one another.

In one embodiment, the jacket encloses and covers only the shell surface of the filter and leaves the two end faces free. The jacket preferably extends along the entire length of the shell surface. In another embodiment, the jacket covers not only the shell surface, but additionally also an area of the inflow-side end face of the filter. The jacket leaves the inflow-side opening free and encloses this inflow-side opening in the manner of a collar. This configuration leads in many cases to a better connection between the jacket and the rigid filter or between the jacket and an optional additional particle filter, which is arranged in front of the inflow-side end face of the rigid filter. In many cases, this embodiment ensures an even better support for the edge between the shell surface and the inflow-side end face of the filter.

In a variant of the above-described two embodiments, the jacket projects over the inflow-side end face. The dimension of the jacket in a direction parallel to the central axis is consequently greater than the dimension of the shell surface of the filter. Since the jacket projects, the risk of the jacketed rigid filter being damaged is reduced further. The projecting jacket is capable up to a certain extent of absorbing kinetic energy based on a mechanical impulse even when this mechanical impulse is directed towards the inflow-side end face. Such an impulse may occur, for example, when the filter unit falls on the ground with the inflow-side end face facing downwards.

The filter unit comprises according to the present invention a rigid cover and a flexible jacket. In one embodiment, the cover is mechanically connected to the jacket. For example, a connection provided by connection in substance (substance-to-substance bond), especially a bonded connection, connects the cover to the jacket.

In another embodiment, the filter unit additionally comprises a rigid housing. The flexible jacket is located between the shell surface of the rigid filter and the rigid housing. The jacket preferably fills out the entire area between the filter and the rigid housing, especially preferably along the entire shell surface of the filter. The rigid cover is mechanically connected to the rigid housing. The rigid housing is capable in this embodiment of absorbing mechanical impulses, which act on the filter unit in parallel or obliquely to the central axis of the filter, and of transmitting them to the cover. Furthermore, the rigid housing protects in many cases the jacket from mechanical and chemical effects from the outside. The thickness of the rigid housing is preferably smaller than the thickness of the flexible jacket. The rigid housing may project, just like the jacket, over the inflow side. The rigid housing preferably encloses the entire shell surface of the jacket.

In one embodiment, the filter unit additionally comprises a film. This film encloses the outer side of the jacket that faces away from the filter. In one embodiment, the film is applied directly to the jacket, and it is applied in another embodiment to the optional rigid housing on the outside. The film preferably encloses the entire jacket or at least the part of the jacket that encloses the shell surface of the filter, or the entire housing. The jacket and the optional rigid housing are consequently located between the filter and the film. The thickness of the film is preferably smaller than the thickness of the jacket and also smaller than the thickness of the optional rigid housing.

The film may be configured such that it is water-repellent and/or repels other chemicals, which may be harmful to the filter. The film may be manufactured from a material possessing flame-retardant properties and it may thereby reduce the risk that the rest of the filter unit will catch fire, i.e., the film may act as a flameproofing material. A mark, for example, a mark that distinguishes a particular filter unit from all other filter units of a set of filter units, or a mark, which specifies the boundary conditions for the application of the filter unit, e.g., a maximum duration of use or a maximum ambient temperature or a maximum ambient humidity, may be applied to the film. The film may reflect light and/or fluoresce and thereby also emit light in a dark environment. This makes it easier, on the one hand, for a user to find the filter unit in order to screw it on, and, on the other hand, to find the user of the filter unit. The film may also absorb light and other electromagnetic weaves and thereby prevent the user from being seen.

A layer of paint or a coating, which brings about a corresponding effect, may also be applied instead of a film.

The gas mixture, for example, the breathing air, flows through the filter unit from the inflow side to the outflow side. In one embodiment, the gas mixture flows at first through a particle filter, which is preferably manufactured from paper, and it then reaches the rigid filter. The rigid filter is consequently arranged between the paper filter and the cover. The particle filter filters particles out of the gas mixture, so that these particles will not reach the rigid filter. The particle filter preferably covers the entire inflow-side end face of the filter, so that particles will not bypass the particle filter and they will then be able to reach the rigid filter.

The embodiment with the particle filter in addition to the rigid filter reduces the risk of particles reaching the user, it reduces the risk of particles in the gas mixture reaching the user, which may be hazardous to the health of the user, and it eliminates the need for the rigid filter to filter particles out of the gas mixture. The embodiment in which the particle filter is arranged upstream of the rigid filter reduces the risk of particles clogging the rigid filter.

In one embodiment, the filter unit additionally has a grip protection (grip guard). This grip protection is arranged in front of the inflow-side opening and is connected to the jacket or to the optional rigid housing, preferably by a connection established by connection in substance (substance-to-substance bond). The rigid filter is consequently located between the grip protection and the rigid cover. The grip protection prevents a user from reaching through the inflow-side opening into the filter unit and from touching the inflow-side end face, which may happen, for example, while attaching or removing the filter unit. In addition, the grip protection reduces the risk of the filter being damaged when the filter unit strikes an object such that the object comes into contact with the inflow-side end face. The grip protection thus prevents the filter from being damaged mechanically by reaching through the inflow-side opening. The grip protection preferably comprises a grid, through which the gas mixture to be cleaned can flow. A distance preferably occurs between the grip protection and the inflow-side end face of the rigid filter.

The optional particle filter is located between the grip protection and the rigid filter. In one embodiment, the particle filter is arranged on the inner side of the grip protection and/or is held by the grip protection in a desired position relative to the rigid filter.

The configuration with the grip protection may be combined with the embodiment in which the jacket projects over the inflow-side end face of the filter. When the grip protection is connected to the projecting jacket or to an optional housing, which likewise projects, a distance is formed between the grip protection and the rigid filter. This configuration leads to a further reduction of the risk of the rigid filter being damaged.

In one embodiment, the filter unit additionally comprises a coupling unit, especially an internal thread or an external thread or a quarter-turn connector. Using this coupling unit, the filter unit can be connected to another device, especially to a face mask or to another mask or to a delivery unit for the gas mixture, the connection preferably being a detachable connection. The coupling unit belongs to the rigid cover or is permanently connected to the cover and is preferably likewise rigid. The outflow-side opening preferably passes through the cover as well as through the coupling unit.

The cover as well as the optional coupling unit are preferably manufactured according to the present invention from a rigid material. The cover carries the jacket made of the deformable material. This embodiment increases the mechanical stability of the filter unit. The cover and the coupling unit may form a single component or two components, which are permanently connected to one another.

In a preferred embodiment, the jacket is connected to the rigid filter by a connection in substance (a substance-to-substance bond). This configuration reduces the risk of movement of the rigid filter relative to the jacket in an undesired manner. It is possible that the jacket is also connected to the rigid housing by a connection in substance (a substance-to-substance bond). A relative movement of the filter could also lead to an undesired movement of the filter relative to the rigid cover or to the rigid housing and damage the filter.

The connection in substance (the substance-to-substance bond) is established on the shell surface, namely, on the entire shell surface or at least on an area of the shell surface. It is also possible that the jacket is stretched by the filter and it therefore seeks to contract and it holds the filter thereby.

The present invention pertains, furthermore, to two processes for manufacturing a filter unit according to the present invention.

According to the first manufacturing process according to the present invention, a shaping body is used, which provides a cavity. A circumferential inner wall of the shaping body defines and limits the cavity.

The manufacturing process with the shaping body comprises the following steps:

A filter is provided. This filter is configured as a rigid body and is manufactured especially from a material which comprises activated carbon. The filter extends along a central axis and has a shell surface and two end faces. The filter is capable of filtering at least one gas and/or particles out of a gas mixture, which flows through the filter.

In addition, a cover consisting of a rigid material is provided.

The rigid filter is inserted into the cavity, which is provided by the shaping body.

The shaping body and the filter are configured and the filter is inserted into the cavity such that the cavity can accommodate the entire filter and a circumferential gap is formed between the circumferential inner wall and the shaping body.

A free-flowing material is inserted into this gap between the shell surface and the shaping body. For example, a bulk material is poured into the gap, or a liquid or viscous material flows into the gap. After its insertion, the free-flowing material in the gap encloses the shell surface of the filter, doing so completely or at least partially.

The free-flowing material present in the gap cures, doing so completely or at least partially. It is consequently possible that the free-flowing material is still free-flowing to a certain extent even after the partial curing. It is possible that the free-flowing material expands or also contracts during the curing.

After the curing, the free-flowing material forms a jacket consisting of a flexible material, especially from a plastic and/or elastic material. This jacket encloses the shell surface of the filter, preferably doing so completely.

It is possible that the jacket projects over an end face of the filter. The jacket leaves an opening each free at both end faces of the filter. These openings act as the inflow-side opening and as the outflow-side opening. Such an opening may release the entire end face or only a part of the end face.

The free-flowing material is preferably connected by the curing to the shell surface of the filter by a connection in substance (a substance-to-substance bond). It is also possible that the free-flowing material contracts during the curing and holds the filter thereby. These embodiments may be combined with one another.

After the free-flowing material has cured completely or at least partially, a workpiece is formed, which comprises the rigid filter and the jacket. The cover is mechanically connected to this workpiece. The outflow-side end face of the filter points towards the cover after the mechanical connection.

The filter, the jacket around the shell surface of the filter and the cover connected to the jacket belong to the filter unit manufactured according to the present invention.

This manufacturing process makes it possible to manufacture the filter, the cover and the free-flowing material separately from one another, even at different locations and with a respective adapted manufacturing process. This manufacture is easier in many cases than if a filter would have to be manufactured first from a rigid body in the jacket.

The free-flowing material preferably becomes connected to a certain extent to the material of the filter during the curing, so that the jacket on the shell surface is connected to the filter by a connection in substance (substance-to-substance bond), said connection being complete or present in at least some areas. The free-flowing material exerts only a slight mechanical effect on the filter in the shaping body when the free-flowing material is inserted into the gap. The risk of the filter being damaged during the filling in of the free-flowing material is therefore relatively low.

The free-flowing material, which is inserted into the cavity provided by the shaping material, adapts itself to the dimensions and to the geometry of the filter and to those of the shaping body. It is not necessary to adapt the shaping body exactly to the geometry and to the dimensions of the filter. Furthermore, it is not necessary to have to manufacture and to provide a fitting jacket in advance.

This manufacturing process makes it possible to manufacture or to provide a relatively large quantity of free-flowing material in a single manufacturing process and to manufacture the jacket for a plurality of filter units according to the present invention from this relatively large quantity.

Due to the free-flowing material in the gap curing at least partially, a workpiece is formed, which comprises the rigid filter and the jacket around the rigid filter.

In a variant of this embodiment, this workpiece is pushed out of the shaping body after the free-flowing material has cured in the gap. The shaping body belongs to a manufacturing mold and can be used to manufacture a plurality of filter units according to the present invention one after another. After the pushing out, the cover is mechanically connected to the jacket. In order to connect the cover to the jacket, the filter element is preferably gripped and held by the jacket being gripped from two opposite sides.

It is also possible that the workpiece is pushed out of the shaping body and into a rigid housing. The rigid cover is connected to this rigid housing.

The shaping body is available again at an early time in this variant for manufacturing another filter unit according to the present invention or for cleaning the shaping body. The shaping body does not hinder the operation of connecting the rigid cover mechanically to the flexible jacket or to the rigid housing.

In a variant of the embodiment, the cover is connected first to the jacket consisting of the cured or curing free-flowing material, while the filter is located in the shaping body. As a result, the filter unit is manufactured in the shaping body. The filter unit is then removed from the shaping body. This variant makes it possible to grip the filter unit by the cover, especially by a coupling unit of the cover and to remove the filter unit gripped in this manner from the shaping body.

In one embodiment, the outer surface of the jacket, which is formed by the curing of the free-flowing material, forms the outer surface of the filter unit. The cover is mechanically connected to the jacket. The shaping body, into which the filter and then the free-flowing material are inserted, belongs to a manufacturing mold. This manufacturing mold is preferably used to manufacture a plurality of identical filter units according to the present invention one after another.

The rigid filters of these filter units according to the present invention may differ from one another in respect to a dimension and/or to their geometry, and the same manufacturing mold can nevertheless be used. Such differences between different copies of the rigid filter are, as a rule, inevitable especially because of manufacturing tolerances. The shaping body can be adapted to predefined requirements, especially to a desired thickness of the jacket, relatively easily.

In a variant of this embodiment, the manufacturing mold further comprises a state change unit. This state change unit changes the state of the free-flowing material in the shaping body from the outside. For example, the state change unit feeds vapor to the free-flowing material and brings about the curing of the free-flowing material thereby. The state change unit does not preferably exert any relevant mechanical effect on the filter.

A rigid housing is provided in another embodiment of the first manufacturing process according to the present invention. This rigid housing is used as the shaping body or it forms a part of the shaping body. A gap is formed between the shell surface of the filter and the inner wall of the rigid housing. The free-flowing material is inserted into this gap and it cures there at least partially. The jacket is between the shell surface of the filter and the inner wall of the rigid housing after the curing. The cover is mechanically connected to the rigid housing.

A plurality of filter units according to the present invention are preferably manufactured one after another by the first manufacturing process according to the present invention. Both the rigid filter and the rigid housing may differ from one another among a plurality of copies in respect to a dimension or to their geometry, especially because of unavoidable manufacturing tolerances. As a result, the gap between the filter and the housing differs from one filter unit to the next. The free-flowing material and the flexible jacket formed from it fit the respective geometry of this gap.

Two embodiments of the shaping body, namely, a shaping body of a manufacturing mold and a rigid housing of the filter unit as the shaping body, were described farther above. It is possible in both embodiments to manufacture a plurality of filter units according to the present invention one after another and to use for this the same free-flowing material each time. It is also possible to manufacture a plurality of filter units with different free-flowing materials one after another in order to manufacture a plurality of filter units with different jacket, which meet different requirements.

A film is optionally applied, for example, bonded to the jacket or to the rigid housing. This film encloses at least the shell surface of the jacket or of the rigid housing. In one embodiment, the film is applied after the free-flowing material has cured and it forms the jacket. The film is especially preferably bonded to the rigid housing on the outside. It is also possible to apply a layer of paint or a coating to the jacket or to the housing. It is also possible to apply the layer of paint or the coating to the housing on the outside before the rigid filter and then the free-flowing material are inserted into the housing.

In another embodiment, the circumferential inner wall of the shaping body is connected to the film, the filter is inserted into the cavity, and the free-flowing material is then filled into the gap. The gap, into which the free-flowing material is inserted, is located in this embodiment between the filter and the film. This embodiment makes it possible in many cases for the curing free-flowing material to become connected by a connection in substance (a substance-to-substance bond) to both the shell surface of the filter and to the inner side of the film. The need to prepare a bonded connection between the film and the jacket is eliminated hereby in many cases.

An alternative process for manufacturing a filter unit according to the present invention comprises the following steps:

A filter is provided. This filter is configured as a rigid body; it extends along a central axis and has a shell surface and two end faces. The filter is capable of filtering at least one gas and/or particles out of a gas mixture, which flows through the filter.

A cover consisting of a rigid material is provided.

A tube (hose) comprised of a flexible material, especially of a plastic and/or elastic material, is provided. The tube is capable of absorbing kinetic energy. This tube extends along a central axis.

A piece is cut off in front of this tube. The length of this cut-off piece, i.e., the dimension of this piece along the central axis of the tube, is at least as great as the distance between the two end faces of the rigid filter, i.e., at least just as great as the extension of the filter along the central axis of the filter. The cut-off piece may be longer than the filter.

The piece cut off from the tube is moved relative to the filter. In particular, the cut-off piece is pulled over the shell surface of the filter, or the filter is pushed into the cut-off piece. The cut-off piece completely encloses the shell surface of the filter after this relative movement. The cut-off piece therefore forms a jacket of the shell surface of the filter after the relative movement. The cut-off piece may project over an end face of the filter.

A workpiece, which comprises the rigid filter and the jacket, which has been formed from the cut-off piece, is prepared now. The cover consisting of the rigid material is connected to this workpiece such that the outflow-side end face of the filter points towards the cover.

The filter, the jacket around the shell surface of the filter and the cover connected to the jacket belong to the filter unit manufactured according to the present invention.

In a variant of this manufacturing process, the relative movement is carried out first and a piece is then cut off from the tube. The tube is consequently pulled over the shell surface of the filter, or the filter is pushed into the tube, and a piece is then cut off from the tube, said tube already enclosing the filter prior to the cutting off

The manufacturing process, in which the filter is pushed into a cut-off piece of a tube or the filter is pushed at first into the tube and a piece is then cut off from the tube or the cut-off piece is pulled over the filter makes it likewise possible to push one after another a plurality of filters having different geometries and/or different dimensions into different pieces of the same tube or conversely, to push the same tube one after another over a plurality of filters and to cut off a piece each. Since the tube is manufactured from a flexible material, the cut-off piece fits to a certain extent the dimensions and the geometries of the filters. The filters may consequently differ in terms of the geometry and/or a dimension from one copy to the next.

It is possible thanks to this manufacturing process to manufacture or to provide a relatively long tube consisting of a flexible material in a single manufacturing operation and to cut off a plurality of pieces from this tube for the jackets of a plurality of filters.

This alternative manufacturing process is preferably carried out several times one after another in order to manufacture a plurality of filter units according to the present invention. A plurality of pieces, namely, one piece per filter unit, are cut off from the same tube one after another. It is possible that differently shaped filter units are used one after another. The tube consisting of the flexible material fits the different geometries of these filters.

It is possible in the alternative manufacturing process as well to manufacture the filter, the rigid cover and the tube at different locations and to use a respective well-suited manufacturing process.

In one embodiment of the manufacturing process with the tube, a rigid housing is provided. In one embodiment, the piece cut off from the tube is moved relative to this rigid housing, so that the rigid housing encloses the piece cut off from the tube after the relative movement. For example, the cut-off piece is pushed into the rigid housing, or the rigid housing is pulled over the cut-off piece. The rigid filter is then moved relative to the cut-off piece in the rigid housing. In another embodiment, the filter is moved relative to the cut-off piece, so that the cut-off piece provides the jacket around the filter. The workpiece comprising the filter and the jacket, which is manufactured from the cut-off piece, is then moved relative to the rigid housing, for example, by the workpiece being pushed into the rigid housing. The rigid cover is then mechanically connected to the rigid housing in both embodiments.

The jacket is optionally enclosed with a film in the alternative manufacturing process as well, in which case the film is manufactured from a material that possesses flame-retardant properties and/or is water-repellent.

The two manufacturing processes according to the present invention show two ways of manufacturing a filter unit with a filter in the form of a rigid body, wherein the risk that the filter will be damaged during the manufacture is reduced compared to other possible manufacturing processes. Both processes make it possible to manufacture the filter separately from the other components of the filter unit. It is made possible to manufacture a large number of filter units one after another.

The present invention will be described below on the basis of a plurality of exemplary embodiments. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a side sectional schematic view showing a filter unit according to the present invention according to the granular material exemplary embodiment;

FIG. 2 is a schematic cross-sectional view in plane A-A of FIG. 1 showing the filter unit according to the granular material exemplary embodiment;

FIG. 3 is a schematic side view showing how a filter unit is manufactured according to the granular material exemplary embodiment and with a rigid housing;

FIG. 4 is a schematic side view showing how a filter unit is manufactured according to the granular material exemplary embodiment and without a rigid housing: granular material is filled in and granular material cures;

FIG. 5 is a schematic view showing the continuation of the granular material exemplary embodiment from FIG. 4: the filter unit is pushed out of the pot;

FIG. 6 is a schematic side view showing a filter unit according to the present invention according to the foamed material exemplary embodiment;

FIG. 7 is a schematic side view showing how a tube is manufactured from liquid plastic for the filter unit according to the foamed material exemplary embodiment;

FIG. 8 is a schematic cross-sectional view in plane B-B of FIG. 7 showing the die for manufacturing the tube from FIG. 7; and

FIG. 9 is a schematic side view showing how a filter unit is manufactured according to the foamed material exemplary embodiment from the tube according to FIG. 7.

### DESCRIPTION OF PREFERRED EMBODIMENTS

Referring to the drawings, the present invention will be used in the exemplary embodiments described below for a gas mask. A person, for example, a member of a firefighting crew or of a police force, can be present by means of this gas mask in an area polluted with a harmful substance and yet inhale breathing air free from harmful substance. This person will hereinafter be called “the user” of the gas mask. Thanks to the gas mask, the user inhales filtered breathing air.

The filter unit may also be used in a respirator. This respirator comprises a face mask, at least one filter unit according to the present invention as well as a delivery unit for gas, for example, a pump. This delivery unit sucks ambient air, which flows through the filter unit according to the present invention or through at least one filter unit according to the present invention. The filter unit according to the present invention or at least one filter unit according to the present invention filters the breathing air sucked in and the user then inhales this breathing air freed of harmful substances.

The gas mask comprises the face mask proper, which is in contact with the face, as well as at least one filter unit, and preferably at least two filter units. The face mask is made of a deformable material in order for it to adapt itself to the shape of the head of the user and to be in contact with the head in a fluid-tight manner, and it comprises for the filter unit or for each filter unit a respective threaded socket, into which a filter unit can be screwed and out of which it can be unscrewed. As an alternative, the filter unit or each filter unit may be connected detachably by means of a respective quarter-turn connector. Thanks to the detachable connection, the user can replace a filter unit without having to remove the face mask.

Two exemplary embodiments of a filter unit 100 according to the present invention, which are called “granular material exemplary embodiment” and “foamed material exemplary embodiment,” will be described below.

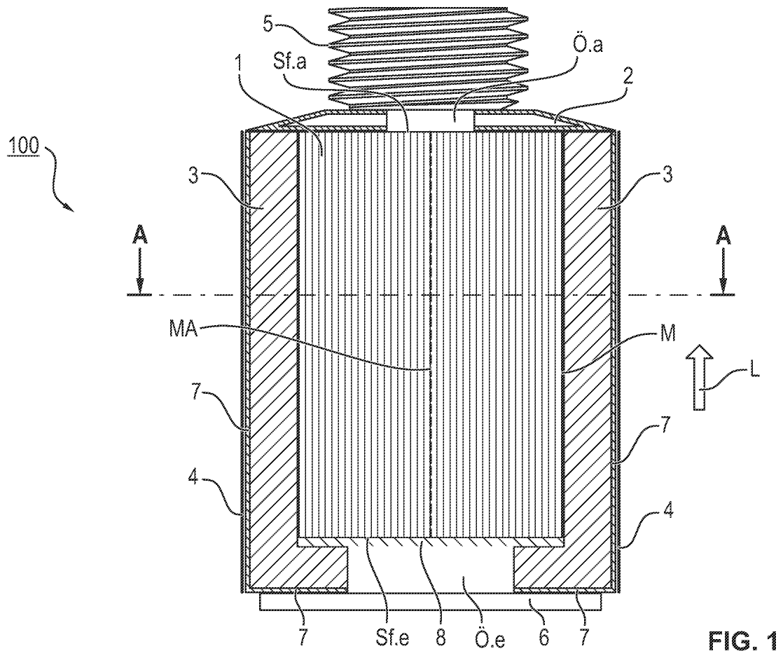

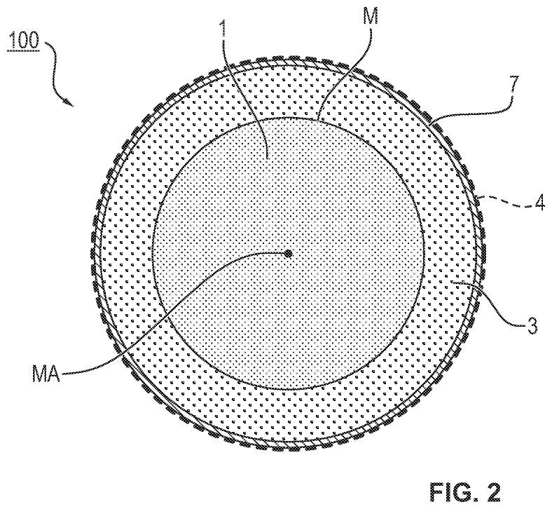

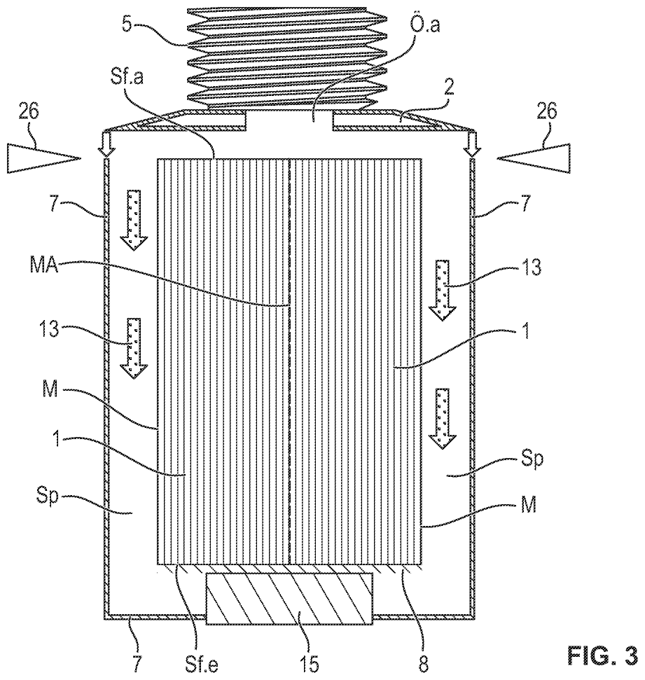

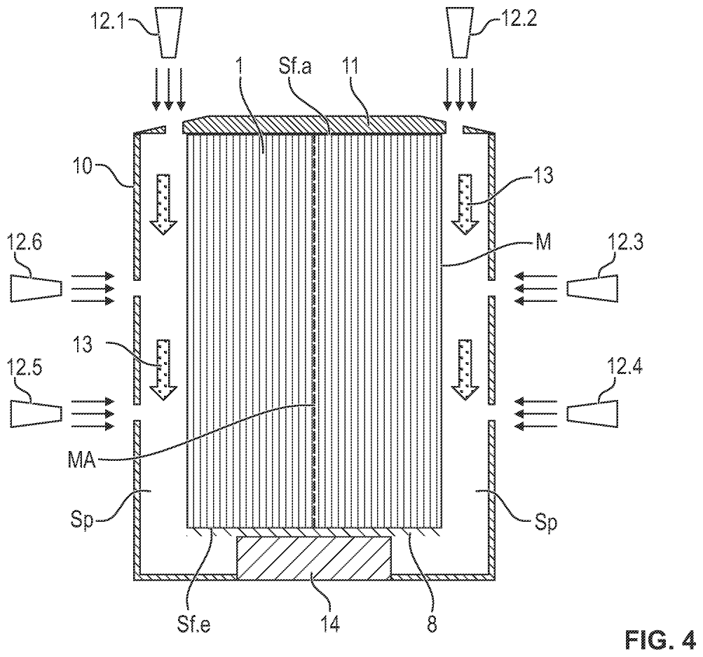

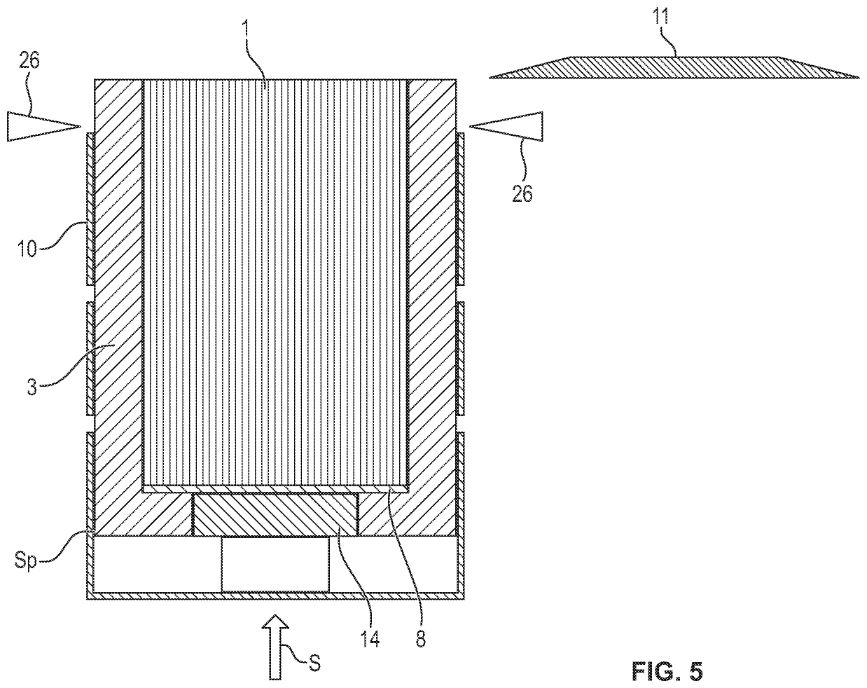

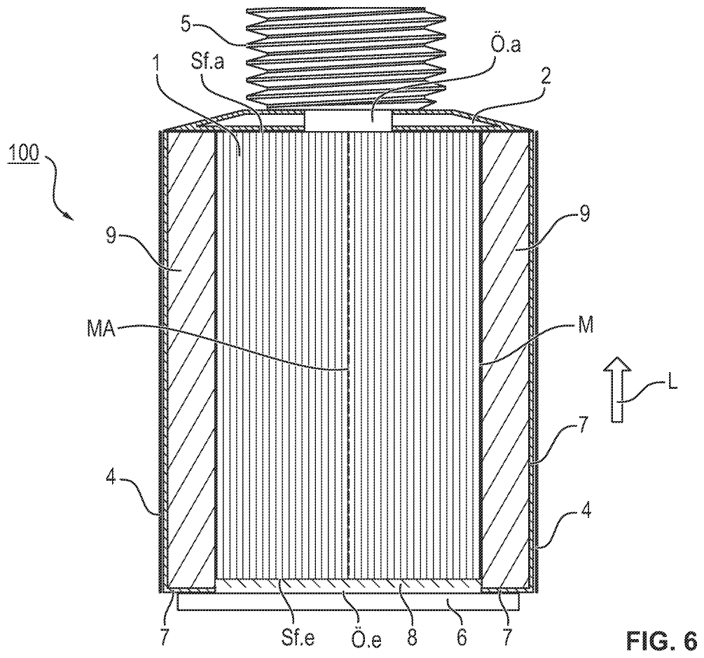

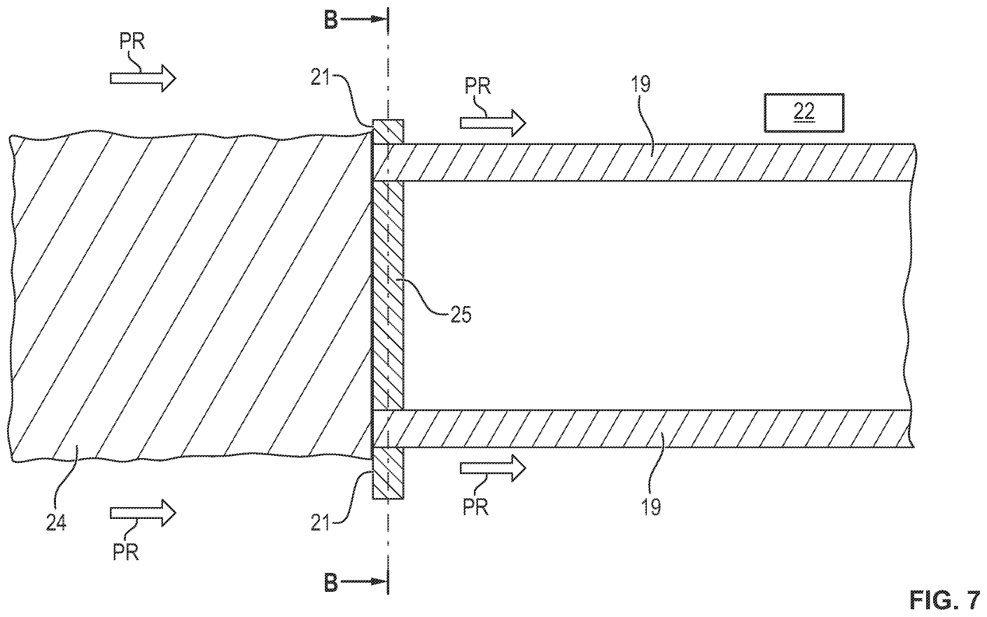

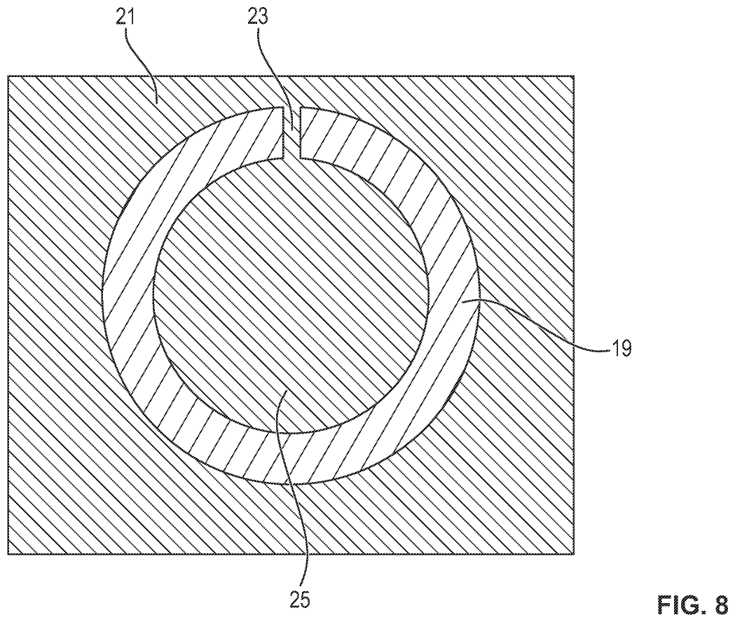

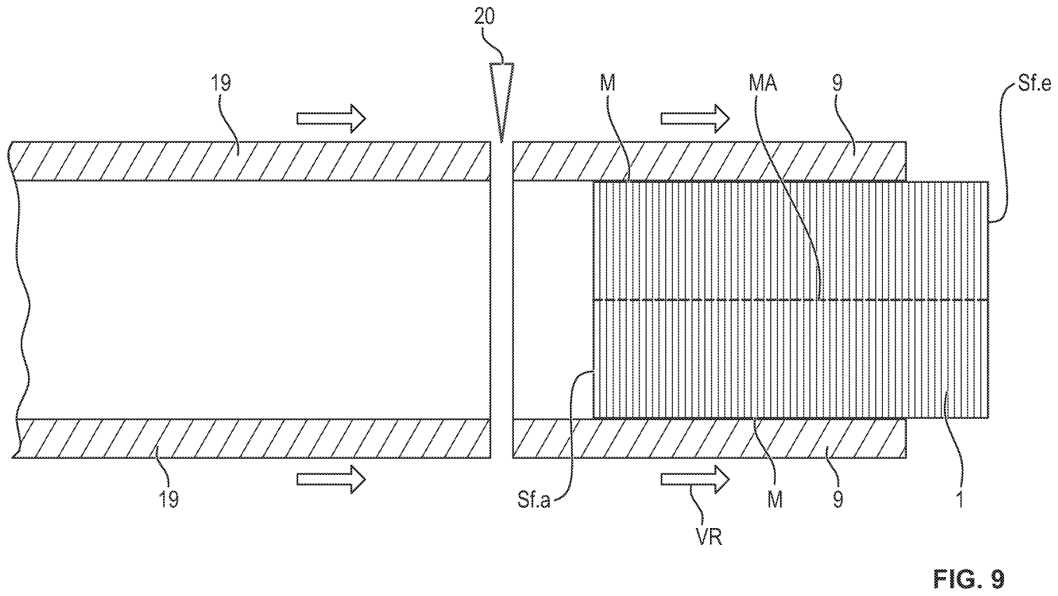

FIG. 1 schematically shows in a side view a filter unit 100 according to the granular material exemplary embodiment, and FIG. 2 shows schematically a cross-sectional view in plane A-A of FIG. 1. FIG. 3 schematically shows in a side view how a filter unit 100 according to the granular material exemplary embodiment with a rigid housing is manufactured. FIG. 4 and FIG. 5 schematically show in a side view the manufacture of a filter unit 100 according to the granular material exemplary embodiment without a rigid housing. FIG. 6 schematically shows in a side view a filter unit 100 according to the foamed material exemplary embodiment. FIG. 7 schematically shows in a side view how a tube (hose) is manufactured from a foamed material, which is then used to manufacture a filter unit 100 according top the foamed material exemplary embodiment. FIG. 8 schematically shows in a cross-sectional view in plane B-B of FIG. 7 the die used to manufacture the filter unit 100 according to FIG. 7. FIG. 9 schematically shows in a side view how a filter unit 100 is manufactured according to the foamed material exemplary embodiment from a tube made of a foamed material. The figures are not necessarily true-to-scale views.

According to the two exemplary embodiments, a filter unit 100 has the shape of a cylinder with a truncated cone, which is attached to the cylinder and which has a thread 5. The filter unit 100 comprises an inflow side, which is shown at the bottom in FIG. 1 and in FIG. 3 through FIG. 6 and through which the inhaled or sucked-in breathing air flows into the filter unit 100, and an outflow side, through which the breathing air flows again out of the filter unit 100 and which is shown at the top. The thread 5 is arranged on the outflow side. The direction in which air flows through the filter unit 100 is shown in FIG. 1 and in FIG. 6 by an arrow L pointing from bottom to upwards.

The inhaled or sucked-in air flows through an inflow-side opening Ö.e on the inflow side into the filter unit 100, it flows through the filter 1 proper and leaves the filter unit 100 again on the outflow side through an outflow-side opening Ö.a. The filter 1 filters at least one gas out of the breathing air, while this breathing air is flowing through the filter. The filter 1 according to the exemplary embodiment is not able to filter any particles out of the breathing air.

In both exemplary embodiments, the filter unit 100 comprises a filter 1 each, which is manufactured with the use of compressed activated carbon and may be called an activated carbon honeycomb monolith. The filter 1 may also be manufactured, e.g., from Ca(OH)₂. The filter 1 is preferably impregnated with a suitable agent. The filter 1 is traversed by a plurality of parallel ducts, which extend parallel to the direction L and are not preferably connected to one another. This filter 1 may have a configuration as described in DE 10 2015 012 410 A1 and have especially a material composition described there. The filter unit 100 is configured such that the breathing air, which flows through the filter unit 100, also flows through the filter 1 and does not bypass the filter 1.

In one embodiment, which is shown in the figures, the filter 1 is a single rigid body in the form of a cylinder. It is also possible that the filter 1 comprises a plurality of disks, which are arranged one after another in a sequence. This configuration makes it easy to manufacture the filter 1 from different materials, so that the filter is capable of filtering out different gases.

A monolithic filter 1 consisting of activated carbon in the form of a rigid body or of a sequence of rigid bodies offers a markedly lower flow resistance and hence breathing resistance than does another filter having a similar filter performance. The use of such a monolithic filter is therefore less stressful for the user than that of another filter. Such a filter is lighter (has a lower weight) in some cases than is another filter having a similar filter performance. In some cases a monolithic filter requires less space than another filter having a similar filter performance.

In the exemplary embodiment, the rigid filter 1 has the shape of a cylinder, which extends along a central axis MA, and a shell surface M, a circular inflow-side end face Sf.e and a circular outflow-side end face Sf.a. The central axis MA and the shell surface M are at right angles to the drawing plane of FIG. 2. The inflow side forms the inflow-side end face Sf.e of the cylinder and the outflow side forms the outflow-side end face Sf.a. The shell surface M extends between these two end faces Sf.e, Sf.e. The rigid filter 1 may also have the shape of a truncated cone, wherein the diameter increases from the inflow-side end face Sf.e to the outflow-side end face Sf.a.

One drawback of a filter that is configured as a rigid body made of activated carbon is the following: A part may break off from the filter 1 or the filter 1 may even break apart in case of a shock. Such a shock occurs, for example, when the filter unit 100 falls on the ground or it strikes a hard object during the use, for example, when the user turns his head.

In both exemplary embodiments, the filter unit 100 comprises a plurality of components, which reduce the risk of the filter 1 being damaged in case of a shock, but they cannot completely rule out this risk. These components will be described below.

The filter unit 100 according to the granular material exemplary embodiment comprises—in addition to the filter 1—the following components:

the thread 5 on the outflow side, wherein the thread 5 is manufactured from a rigid material, preferably from a metal or from a rigid plastic,

a cover 2 consisting of a rigid material, preferably of a metal or of a rigid plastic, wherein the cover 2 has the shape of a truncated cone,

a housing 7 consisting of a rigid material, wherein the housing 7 comprises a tube,

a jacket 3 consisting of an elastically deformable material in the form of cured granular material,

a particle filter 8 in front of the inflow-side end face Sf.e of the filter 1,

optionally a flame protection 4 in the form of a film or of a layer of paint or coating around the housing 7, and

a grip protection 6 in front of the inflow-side opening Ö.e.

The jacket 3 consists of cured granular material in the granular material exemplary embodiment shown. It is also possible to use other elastic materials, for example, a thermoplastic elastomer, an epoxy resin or another synthetic or natural resin, a polyurethane, a butyl compound, a silicone or even an elastomeric hot-melt adhesive. If the jacket 3 is enclosed by a rigid housing 7, it is also possible for the jacket 3 not to be fully cured.

The jacket 3 is located between the shell surface M of the rigid filter 1 and the tube of the rigid housing 7. The jacket 3 preferably fills the space between the shell surface M of the filter 1 and the rigid housing 7 completely.

The jacket 3 preferably is connected to the shell surface M of the cylindrical filter 1 by a connection in substance (a substance-to-substance bond) during the manufacture of the filter unit 100. A manufacturing process will be described farther below. No separate step is preferably necessary to connect the jacket 3 to the filter 1. In particular, no bonded connection or snap connection is necessary. In addition, an additional layer, for example, a layer of a nonwoven, is not necessarily present between the shell surface M of the filter and the jacket 3.

According to the present invention, the jacket 3 is elastic. As a result, the jacket 3 provides a springy effect (spring effect), which further reduces the risk of the filter 1 being damaged. The thickness of the jacket 3 is shown in an exaggerated form in FIG. 1, FIG. 5 and FIG. 6.

The jacket 3 absorbs kinetic energy, which acts on the filter unit 100 from the outside, and it protects hereby the filter 1 and especially the shell surface M thereof and the two transitions between the shell surface M and the two end faces Sf.e, Sf.a from mechanical damage to a certain extent. In one embodiment, the jacket 3 provides an integral wall, i.e., the hardness of the jacket 3 decreases from the outside to the inside. As a result, the jacket 3 is even more capable of absorbing kinetic energy. The elasticity of the jacket 3 is preferably greater on the inside, i.e., in an area that is adjacent to the filter 1, than on the outside.

The thickness of the jacket 3, i.e., the minimal dimension at right angles to the central axis MA, is between 0.5 mm and 1.5 mm in the exemplary embodiment. In general the thickness is preferably between 0.1 cm and 1.5 cm, in particular between 0.5 cm and 1 cm.

The housing 7 has the shape of a cylinder, which is fully open at the outflow-side end face, and it releases the circular opening Ö.e at the inflow-side end face, it is made of a metal or a rigid plastic, and it encloses the jacket 3. The cover 2 is connected to the housing 7 by a connection in substance (a substance-to-substance bond) or by a snap connection. In one embodiment, the cover 2 is additionally connected to the end face of the jacket 3, which end face points towards the outflow side, preferably by a bonded connection, and optionally additionally or instead of this by a snap connection. The thread 5 is permanently connected to the cover 2.

It is possible that an impulse acts on the filter unit 100 in parallel or obliquely to the central axis MA on the cover 2, doing so from the inflow-side opening Ö.e. This impulse is introduced into the rigid housing 7.

The flame protection film 4 is led around the outwardly facing surface of the housing 7 and is connected to same by a connection in substance (a substance-to-substance bond), preferably by a bonded connection. The flame protection film 4 makes it possible in some applications for the filter unit 100 to be able to withstand a higher temperature compared to a configuration without a flame protection film 4. The heat resistance of the housing 7 and of the jacket 3 is sufficient in other applications, so that a flame protection film 4 is not necessary. The flame protection film 4 may also be necessary in some applications for the filter unit 100 to be able to be used in an environment with a high atmospheric humidity or in heavy rain, optionally in conjunction with a high temperature. A mark of the filter unit 100 may be applied to the flame protection film 4. For example, this mark distinguishes the filter unit 100 from all other filter units, which are used in a certain area. This mark may be associated with information on the filter unit 100, this information optionally being stored in a data bank, e.g., a maximum duration of use. The flame protection film 4 may reflect light and other electromagnetic waves or it may fluoresce or also absorb.

In an alternative embodiment (not shown), the rigid housing 7 is omitted. The cover 2 is connected now to the jacket 3 by a connection in substance (a substance-to-substance bond). The flame protection film 4 is applied to the outwards facing surface of the shell surface of the jacket 3.

The grip protection (grip guard) 6 prevents a finger of the user or a larger object from touching the inflow-side end face Sf.e of the filter 1 from the outside through the inflow-side opening Ö.e, which could lead to a damage to or to a contamination of the filter 1. The grip protection 6 preferably has the shape of a grid and is manufactured from a plastic or a metal, for example, by molding or by injection molding. The gas mixture to be filtered can flow through the grip protection 6. The grip protection 6 is attached to the inflow-side end face of the rigid housing 7 in the exemplary embodiment.

A particle filter 8, which filters particles out of the air flowing through, is located in the exemplary embodiment in front of the inflow-side end face Sf.e of the filter 1 when viewed in the flow direction L. This particle filter 8 is located between the grip protection 6 and the filter 1, it preferably consists of paper and it preferably has the form of a pleated filter or even the shape of a ring filter. Micro glass fibers and/or polymer fibers, and optionally additional small quantities of cellulose are optionally added to the paper of the particle filter 8.

The jacket 3 projects over the inflow-side end face Sf.e of the filter 1 in the granular material exemplary embodiment. The grip protection 6 is connected by a connection in substance (a substance-to-substance bond) to the edge of the rigid housing 7, which edge points towards the inflow side, and additionally to the inflow-side end face of the jacket 3. A distance is therefore formed between the inflow-side end face Sf.e of the filter 1 and the grip protection 6. This leads to a further reduction of the risk of damage.

The jacket 3 may also project over the inflow-side end face Sf.e if no grip protection is present. The section over which the jacket 3 projects is shown in an exaggerated form in the figures. The jacket 3 preferably projects by a few mm and especially preferably by less than 1 mm.

In one embodiment, the inflow-side opening Ö.e occupies the entire inflow-side end face Sf.e on the inflow side of the filter unit 100. In another embodiment, which is shown in FIG. 1, the jacket 3 fully encloses not only the shell surface M of the filter 1, but additionally also the inflow-side opening Ö.e and is in contact in a ring-shaped manner with the end face Sf.e of the filter 1, which end face faces the inflow-side opening Ö.e. As a result, the jacket 3 protects the filter 1 up to a certain extent from a mechanical damage even when a mechanical impulse acting from the inflow side acts on the filter unit 100, especially when the filter unit 100 falls on the ground with the grip protection 6 pointing forward. The grip protection 6 is connected to the jacket 3 and has a distance to the inflow-side end face Sf.e.

FIG. 3 through FIG. 5 schematically show two preferred embodiments of a process for manufacturing a filter unit 100 according to the granular material exemplary embodiment. Granular material 13, which has the form of a bulk material at room temperature and at a sufficient humidity of the air, is used in both embodiments. When the granular material 13 is heated and the humidity of the air is optionally increased additionally, this granular material 13 becomes liquid or semiliquid and expands. The granular material 13 solidifies during the subsequent cooling and preferably does not contract again at all or it does not at least contract again to the extension seen prior to the heating. This granular material 13 may also be called a curing particle foam. Examples of materials from which such granular material 13 can be manufactured are:

expandable polypropylene (EPP),

expandable polystyrene (Styropor, EPS), and

another partially crystalline thermoplastic.

Instead of granular material 13, it is also possible to prepare an alternative material, which is free-flowing and cures at least up to a certain extent, for example, by cooling or by a curing agent being added to the material prior to the use. The alternative material is, for example, a foam or another material as mentioned above.

A filter unit 100 with a rigid housing 7 is manufactured in the example according to FIG. 3 from a metal or from a hard plastic. The housing 7 has the shape of a cylinder with a fully open first end face and with a second end face, in which a circular opening, which is enclosed by a circular ring of the housing 7, is formed.

The rigid filter 1, the rigid housing 7 as well as the cover 2 with the thread 5 are provided. The housing 7 is placed on a substrate such that the second end face points downwards. A disk-shaped placeholder 15 is inserted into the circular opening. The placeholder 15 fills the opening in the second end face completely. The particle filter 8 is placed on the placeholder 15. The rigid filter 1 is placed on the particle filter 8 such that the inflow-side end face Sf.e points towards the particle filter 8 and hence towards the placeholder 15. A circumferential gap Sp is formed between the shell surface of the housing 7 and the shell surface M of the filter 1.

The free-flowing granular material 13 is poured into this gap Sp from the top or is filled in in another manner, for example, after it has been heated. The granular material 13 flows downwards and fills out the gap and encloses the placeholder 15. The gap is preferably configured to allow no or only a small quantity of free-flowing granular material 13 to enter the ducts of the filter 1 and to prevent said ducts from becoming clogged. It may be useful in some cases for granular material 13 to enter into the ducts to a low extent in order to connect the filter better to the granular material 13. The granular material 13 is bound in many cases to the rigid filter 1 to a certain extent.

The granular material 13 cures, for example, by being cooled or by a curing agent in the granular material 13 undergoing a chemical change. As soon as the granular material 13 has cured to a sufficient extent, the placeholder 15 is removed, so that the inflow-side opening Ö.e is formed. A cutting tool 26 shown schematically cuts off the granular material 13, which projects upwards over the housing 7.

The cover 2 with the thread 5 is placed on the housing 7 from the top and is mechanically connected to the housing 7. The flame protection film 4 is optionally bonded to the shell surface of the housing 7. A filter unit 100 according to FIG. 1 and FIG. 2 has thus been manufactured now.

FIG. 4 and FIG. 5 schematically show the manufacture of a filter unit 100 without a rigid housing 7. FIG. 4 shows the following components of a mold, which is used to manufacture such a filter unit 100, and is preferably used to manufacture a plurality of identical filter units 100 according to the present invention one after another:

a shaping body (reusable original form) 10 in the form of a cylindrical pot, in the shell surface of which a plurality of openings are formed,

a cover 11 for the shaping body 10, in which a plurality of openings are preferably likewise formed,

a disk-shaped projection 14 at the bottom of the pot-shaped body 10, and

a plurality of nozzles 12.1, . . . , 12.6 at the level of the openings in the shell surface of the body 10.

The inner wall of the pot-shaped body 10 defines and encloses a cylindrical cavity. The diameter of this cavity is greater than the diameter of the cylindrical filter 1. A circumferential gap Sp is formed therefore between the shell surface M of the filter in the body 10 and the inner wall of the shell surface of the body 10.

The manufacturing process according to FIG. 4 and FIG. 5 comprises the following steps:

The pot-shaped body 10 is positioned or will be positioned such that it is open upwards.

A particle filter 8 is optionally placed on the bottom of the pot-shaped body 10 or on the projection 14.

The filter 1 is manufactured or provided and inserted into the pot-shaped body 10 such that the central axis MA of the filter 1 is identical to the central axis of the pot 10 and an end face of the cylindrical filter 1 stands on the projection 14 and the other end face points upward. The projection 14 is smaller than the end face, so that the end face, which stands on the projection 14, becomes the inflow-side end face Sf.e, and the other end face becomes the outflow-side end face Sf.a. The filter 1 is optionally placed on the particle filter 8 such that the inflow-side end face Sf.e touches the particle filter 8.

Granular material 13, which, as was described above, has the form of a bulk material at room temperature, is inserted into the gap Sp from the top. The quantity of granular material 13 inserted is preferably such that the entire gap Sp will be filled with granular material 13 up to the top edge of the body 10. It is also possible that an upper area of the gap Sp remains free from granular material 13.

The cover 11 is placed on the shaping body 10 and is connected preferably detachably to the body 10.

The nozzles 12.1, . . . , 12.6 discharge hot water vapor or another hot vapor, cf. FIG. 4.

This hot vapor passes through the openings in the shell surface of the body 10 as well as in the cover 11 and reaches the granular material 13 in the gap Sp.

The granular material 13 becomes liquid or semiliquid because of the vapor and the heating and the granular material 13 expands in the process.

The feed of heated vapor is ended. The granular material 13 in the gap Sp undergoes curing. The curing of the granular material 13 in the gap Sp is limited by the shaping body 10 and by the cover 11 on one side and by the filter 1 on the other side. The granular material 13 is cured therefore under pressure. The granular material 13 optionally contracts during the curing.

In one embodiment, the granular material 13 is bonded during the curing to a certain extent to the filter 1 by a connection in substance (a substance-to-substance bond).

After the curing, the cured and solidified granular material 13 forms the jacket 3 around the shell surface M and around a part of the inflow-side end face Sf.e of the filter. The disk-shaped projection 14 causes the inflow-side opening Ö.e to be formed. Liquid granular material 13 can penetrate into the ducts in the filter 1 from the bottom, but not from the side. The inflow-side opening Ö.e remains free from granular material thanks to the projection 14.

After the granular material 13 has cured completely, a deformable jacket 3 is formed around the filter 1. In one embodiment, this jacket 3 is connected to the shell surface M of the filter 1 by a connection in substance (a substance-to-substance bond).

The cover 11 is removed again, and the jacketed filter 1 is pushed out of the body 10 in direction S, cf. FIG. 5.

In one embodiment, the projection 14 belongs to a punch, which is extended and pushes the jacketed filter 1 out of the body 10 in direction S.

While the filter 1 is being pushed out of the pot 10, granular material 13, which has swollen to the extent of passing through the openings in the shell surface of the body 10, is cut off by means of a cutting tool 26 and is separated thereby from the jacket 3. The cover 11 is optionally displaced or pivoted in a direction that is at right angles to the direction S such that granular material 13, which has also escaped through openings in the cover 11, is cut off as well.

A cylindrical jacketed filter 1 is now manufactured. The flame protection film 4 is optionally connected to the shell surface M of the jacketed filter 1 by a connection in substance (a substance-to-substance bond), preferably by bonding.

The cover 2 and the thread 5 are manufactured and are connected to one another, which is preferably carried out separately from the manufacture and the jacket of the filter 1.

The cover 2 is connected to the end face Sf.a of the jacket 3, which said end face points towards the exhalation side, preferably by a connection in substance (a substance-to-substance bond), especially preferably by bonding.

A filter unit 100 suitable for use has now been manufactured.

In a variant of this process, not shown, the cover 2 comprising the thread 5 is connected to the upwards pointing end face of the jacket 3, while the jacketed filter 1 is still in the shaping body 10.

In another variant of the process, not only the filter 1, but additionally also the film 4 are also inserted into the pot 10 prior to the filling in of the granular material 13. The film 4 is brought from the inside against the circumferential inner wall of the pot 10, so that no distance will ideally develop between the film 4 and the inner wall. The granular material 13 is then inserted into the gap Sp between the film 4 and the filter 1. After hot vapor has been fed, the granular material 13 is bonded by a connection in substance (a substance-to-substance bond) both to the filter 1 and to the film 4. In one embodiment, the hot vapor is introduced from the top through the cover 11 and from the bottom through openings in the bottom of the pot 10, while the shell surface of the pot 10 has no openings.

FIG. 6 shows a filter unit 100 according to the foamed material exemplary embodiment. Identical components have the same reference numbers as in the filter unit 100 according to the granular material exemplary embodiment (FIG. 1 and FIG. 2).

The filter unit 100 according to the foamed material exemplary embodiment has a jacket 9 in the form of a molding made from a deformable material, especially from at least one of the following materials, optionally from a mixture of a plurality of the following materials:

expanded thermoplastic foamed material,

silicone elastomer, and

elastomer from natural rubber (colloquially called “rubber”),

instead of a jacket 3 consisting of cured granular material 13.

This jacket 9 absorbs kinetic energy just as the jacket 3 does and encloses the entire shell surface M of the filter 1, but it does not cover in this exemplary embodiment an end face Sf.e, Sf.a of the filter 1 and it also does not project over the inflow-side end face Sf.e of the filter 1. The inflow-side opening Ö.e therefore occupies the entire end face Sf.e of the filter 1, which end face points towards the inflow side. A rigid housing 7 encloses the shell surface of the jacket 9 and the inflow-side opening Ö.e. The grip protection 6 is connected to the housing 7 by a connection in substance (a substance-to-substance bond) and it covers the inflow-side opening Ö.e and therefore the entire end face Sf.e pointing towards the inflow side. A particle filter 8 is located between the grip protection 6 and the inflow-side end face Sf.e.

The jacket 9 is manufactured in a preferred embodiment from an endless tube 19 consisting of one of the above-mentioned deformable materials. FIG. 7 and FIG. 8 show how this tube 19 is manufactured from a liquid plastic 24. A preferred device for manufacturing the tube 19 comprises the following components:

a die 21 with a round mandrel 25 and with at least one web 23,

a bonding tool 22 and

a feeding tool, not shown.

The die 21 extends in a plane that is at right angles to the drawing plane of FIG. 7 and is located in the drawing plane of FIG. 8. FIG. 8 shows the die 21 in plane B-B of

FIG. 5. The die 21 has a circular recess. The web 23 or the webs holds/hold the round mandrel 25 in the center of this circular recess, so that the die 21 provides as a whole a recess in the form of a circular ring (torus).

The feeding tool presses liquid plastic 24 through this recess in the form of a circular ring. This plastic 24 was preferably mixed before chemically and/or physically with propellant gases. It is suggested by arrows PR in FIG. 7 in what direction the feeding tool presses the molten plastic 24 through the die 21. An endless tube is produced hereby, which will then undergo curing and becomes the tube 19 consisting of the deformable material by the curing. The bonding tool 22 closes the slot or each slot in this tube, which the web 23 produces.

FIG. 9 schematically illustrates a possible type of embodiment of the jacket 9 with the use of the endless tube 19. The preferred manufacturing process comprises the following steps:

A cutting tool shown schematically with a cutting edge 20 cuts off a piece from the tube 19. The length of this piece of tube is preferably equal to the length of the filter 1, i.e., equal to the distance between the two end faces Sf.e, Sf.a of the filter 1. The piece of tube cut off may also be longer than the filter 1.

This piece of tube is pulled over the filter 1 such that the inner wall of the piece of tube slides over the shell surface M of the filter 1 being held detachably. It is also possible that the filter 1 is pushed into the piece of tube. The piece of tube is moved in both cases in a feed direction VR relative to the filter 1.

The cut-off piece of tube forms the jacket 9 after the relative movement in both cases. The shell surface M of the filter 1 is fully enclosed by the jacket 9 after the relative movement. The cover 2 with the thread 5 is connected to an end face of this jacket 9 by a connection in substance (substance-to-substance bond), and the grip protection 6 is connected to the other end face.

In one variant, the tube 19 is pulled first over the filter 1 or the filter 1 is pushed into the tube 19, while the inner wall of the tube 19 slides over the shell surface M of the filter 1. The piece of the tube 19 that encloses the shell surface M is then cut off by means of the cutting edge 20 from the rest of the tube 19.

It is possible that the tube 19 or the cut-off piece of tube are heated and they expand hereby. The filter 1 is pushed into the expanded tube 19 or into the expanded cut-off piece of tube. The tube 19 or the piece of tube contract again and hold the filter 1 firmly.

In another embodiment, the workpiece comprising the rigid filter 1 and the cut-off piece of tube is pushed into a rigid housing 67, or the rigid housing 7 is pulled over this workpiece. The cover 2 with the thread 5 is then connected to the rigid housing 7 by a connection in substance (a substance-to-substance bond).

While specific embodiments of the invention have been shown and described in detail to illustrate the application of the principles of the invention, it will be understood that the invention may be embodied otherwise without departing from such principles.

### LIST OF REFERENCE CHARACTERS

1 Filter consisting of activated carbon (monolith), has the shape of a cylinder with a shell surface M and with two end faces Sf.e, Sf.a, traversed by parallel ducts
2 Cover of the filter unit 100, connected to the rigid housing 7 or to the particle foam 3 or to the piece of tube 9 by a connection in substance
3 Jacket in the form of cured granular material 13, encloses the shell surface M of the filter, may project over the inflow-side end face Sf.e, is prepared from the granular material 13, is enclosed by the rigid housing 7
4 Optional flame protection film, bonded on the outside to the rigid housing 7 or to the jacket 3, 9
5 Thread, connected permanently to the cover 2
6 Grip protection in front of the inflow-side opening Ö.e
7 Rigid housing, has the shape of a cylinder, encloses the jacket 3, 9
8 Optional particle filter consisting of paper in front of the inflow-side end face Sf.e, is located between the filter 1 and the grip protection 6
9 Jacket consisting of a deformable material, especially of thermoplastic foamed material or elastomer, encloses the shell surface M of the filter 1, is prepared from the tube 19, wherein the cutting edge 20 cuts off a piece from the tube 9
10 Shaping body (original form) of a pot, defines a cylindrical cavity for receiving the filter 1
11 Cover for the shaping body 10
12.1, . . . Nozzles, which eject hot vapor into the interior of the pot 10
13 Granular material, which is filled into the rigid housing 7 or into the shaping body 10 and then encloses the shell surface M of the filter 1, acts as the free-flowing material
14 Disk-shaped projection at the bottom of the shaping body 10, which projection produces the inflow-side opening Ö.e, pushes the jacketed filter 1 out of the body 10
15 Disk-shaped placeholder for the inflow-side opening in the jacket 3, arranged at the bottom of the housing 7 during the manufacture
19 Endless tube consisting of thermoplastic foamed material, from which the jacket 9 is cut off
20 Cutting edge, which cuts off the jacket 9 from the tube 19
21 Die, through which liquid plastic 24 is pressed in order to produce the tube 19, comprises the mandrel 25 and the web 23
22 Bonding tool, which closes the tube 19
23 Web in the die 21, holds the mandrel 25
24 Liquid plastic, from which the tube 19 is produced, optionally mixed with propellant gases
25 Mandrel in the die 21, held by the web 23
26 Cutting tool, which cuts off granular material 13, which projects over the pot 10 after curing
100 Filter unit, comprises the filter 1, the cover 2, the thread 5 and the grip protection 6 as well as the jacket 3 consisting of cured granular material (granular material exemplary embodiment) or the jacket 9 consisting of foamed material or rubber (foamed material exemplary embodiment)
L Direction in which sucked-in breathing air flows through the filter unit 100
M Shell surface of the cylindrical filter, enclosed by the jacket 3, 9
MA Central axis of the cylindrical filter 1
Ö.a Outflow-side opening, arranged in the cover 2
Ö.e Inflow-side opening, protected by the grip protection 6
PR Direction in which the feeding tool presses the liquid plastic 24 through the die 21
S Direction in which the punch with the projection 13 pushes the jacketed filter 1 out of the shaping body 10
Sf.a Outflow-side end face of the cylindrical filter 1, it is at right angles to the central axis MA
Sf.e Inflow-side end face if the cylindrical filter 1, it is at right angles to the central axis MA
Sp Gap between the inner wall of the rigid housing 7 or the shell surface M of the shaping body 10 and the shell surface M of the filter 1 in the housing 7/body 10, is filled with granular material 13
VR Feed direction, in which the tube 19 is moved relative to the filter 1 in order to produce the jacket 9

What is claimed is:

1. A filter unit comprising:
a filter configured as a rigid body, the filter extending along a central axis and having a shell surface surrounding the central axis and configured to filter at least one gas and/or particles out of a gas mixture, which flows through the filter;
a jacket comprised of an elastically deformable material wherein the jacket encloses the shell surface of the filter and is configured to absorb kinetic energy, which acts on the shell surface; and
a cover formed of a rigid material, wherein the filter unit has an inflow side with an inflow-side opening and an outflow side with an outflow-side opening formed in the cover, wherein the filter unit is configured for a gas mixture to flow from the inflow side through the inflow-side opening, through the filter and through the outflow-side opening to the outflow side, and wherein the cover adjoins the jacket at an end of the jacket, which end points towards the outflow side.

2. A filter unit in accordance with claim 1, wherein the jacket has a springy effect.

3. A filter unit in accordance with claim 1, wherein:
a hardness of the jacket decreases in a direction towards the central axis of the filter; or
an elasticity of the jacket increases in a direction towards the central axis of the filter; or
the hardness of the jacket decreases in a direction towards the central axis of the filter and the elasticity of the jacket increases in a direction towards the central axis of the filter.

4. A filter unit in accordance with claim 1, wherein the jacket has a thickness of at least 0.1 cm and at most 1.5 cm.

5. A filter unit in accordance with claim 1, wherein:
the filter has an inflow-side end face and an outflow-side end face; and
the jacket projects over the inflow-side end face and surrounds the inflow-side opening.

6. A filter unit in accordance with claim 5, wherein the jacket covers an area of the inflow-side end face of the filter.

7. A filter unit in accordance with claim 1, wherein the cover is connected to the jacket at the end of the jacket that points towards the outflow side.

8. A filter unit in accordance with claim 1, further comprising a rigid housing, wherein:
the jacket is located between the shell surface of the filter and the rigid housing; and
the cover is mechanically connected to the rigid housing at an end of the rigid housing, which end points towards the outflow side.

9. A filter unit in accordance with claim 8, further comprising a film enclosing an outer surface of the rigid housing.

10. A Filter unit in accordance with claim 8, further comprising a grip protection in front of the inflow-side opening, wherein the grip protection is connected to the rigid housing.

11. A filter unit in accordance with claim 1, further comprising a film enclosing an outer side of the jacket.

12. A Filter unit in accordance with claim 1, further comprising a grip protection in front of the inflow-side opening, wherein the grip protection is connected to the jacket.

13. A filter unit in accordance with claim 1, wherein the jacket is connected at the shell surface of the filter to the filter by a substance-to-substance bond.

14. A respirator comprising:
a respirator component; and
at least one filter unit comprising:
a filter configured as a rigid body, the filter extending along a central axis and having a shell surface surrounding the central axis and configured to filter at least one gas and/or particles out of a gas mixture, which flows through the filter;
a jacket comprised of an elastically deformable material wherein the jacket encloses the shell surface of the filter and is configured to absorb kinetic energy, which acts on the shell surface; and
a cover formed of a rigid material, wherein the at least one filter unit has an inflow side with an inflow-side opening and an outflow side with an outflow-side opening formed in the cover, wherein the at lest one filter unit is configured for a gas mixture to flow from the inflow side through the inflow-side opening, through the filter and through the outflow-side opening to the outflow side, and wherein the cover adjoins the jacket at an end of the jacket, which end points towards the outflow side.

15. A respirator according to claim 14, wherein the respirator component comprises a gas mask and the at least one filter unit is configured to filter at least one gas and/or particles out of breathing air flowing though the gas mask.

16. A process for manufacturing a filter unit, the process comprising the steps of:
providing a shaping body, wherein the shaping body provides a cavity and
providing a filter configured as a rigid body that extends along a central axis, that has a shell surface which surrounds the central axis and that has an inflow-side end face and an outflow-side end face, wherein the filter is configured to filter at least one gas and/or particles out of a gas mixture, which flows through the filter;
providing a cover formed of a rigid material;
inserting the filter into the cavity provided by the shaping body such that a gap is formed between the shell surface of the filter and a circumferential inner wall of the shaping body;
inserting a free-flowing material into the gap such that the free-flowing material in the gap encloses the shell surface of the filter;
curing the free-flowing material in the gap or enabling the free-flowing material to cure with the cured material forming a jacket made of a flexible material, which fully encloses the shell surface of the filter and leaves free a respective opening at each of two end faces of the filter; and
connecting the cover mechanically to the workpiece formed after the curing such that the outflow-side end face of the filter points towards the cover, wherein the filter, the jacket and the shell surface of the filter and the connected cover together form a manufactured filter unit.

17. A process in accordance with claim 16, wherein:
a rigid housing with an inner wall is provided as the shaping body or as a part of the shaping body;
the gap, into which the free-flowing material is inserted, is formed between the shell surface of the filter and the inner wall of the rigid housing;
the jacket is formed after the curing of the free-flowing material located between the shell surface of the filter and the inner wall of the rigid housing; and
the step of connecting the cover to the workpiece comprises the step of connecting the cover mechanically to the rigid housing.

18. A process in accordance with claim 16, wherein:
after the free-flowing material is cured, the workpiece comprising the filter and the jacket is pushed out of the shaping body; and
the step of connecting the cover to the workpiece comprises the step of connecting the cover to the jacket.

19. A process for manufacturing a filter unit, the process comprising the steps of:
providing a filter configured as a rigid body extending along a central axis and having a shell surface, which encloses the central axis, and having an inflow-side end face and an outflow-side end face, the filter being configured to filter at least one gas and/or particles out of a gas mixture, which flows through the filter;
providing a cover formed of a rigid material;
providing a tube formed of a flexible material;
cutting off a piece from the tube, a length of said piece being equal to or greater than a distance between the two end faces of the filter;
moving the tube or the piece cut off from the tube relative to the filter such that the cut-off piece fully encloses the shell surface of the filter after the relative movement and forms a jacket of the filter;
connecting the cover to the workpiece formed after the relative movement such that the outflow-side end face of the filter points towards the cover, wherein the filter, the jacket and the shell surface of the filter and the cover connected to the jacket together form a manufactured filter unit.
